(19) United States
(12) Patent Application Publication
(10) Pub. No.: US 2013/0125333 A1
(43) Pub. Date: May 23, 2013

(54) WINDSHIELD WIPER WITH WIPER STRIP CARRIER

(71) Applicant: Pylon Manufacturing Corp., Deerfield Beach, FL (US)

(72) Inventors: Vambi Raymundo Tolentino, Coconut Creek, FL (US); Robert Peter Peers, Boca Raton, FL (US)

(73) Assignee: Pylon Manufacturing Corp., Deerfield Beach, FL (US)

(21) Appl. No.: 13/679,646

(22) Filed: Nov. 16, 2012

Related U.S. Application Data
(60) Provisional application No. 61/560,911, filed on Nov. 17, 2011.

(51) Int. Cl. B60S 1/38

(52) U.S. Cl. CPC B60S 1/38
USPC 15/250.451

(57) ABSTRACT

A wiper strip carrier for a windshield wiper that having a horizontal body, claw-like legs, each of which has a vertical portion extending down from the horizontal body and a horizontal portion extending inwardly from the vertical portion such that the claw-like legs form therebetween a first cavity for a top portion of a wiper strip, and second cavity for a single metal vertebra. The invention also is directed to wiper blades incorporating such carriers.

### CROSS-REFERENCE TO RELATED APPLICATIONS

This application claims the benefit of U.S. Provisional Application No. 61/560,911 filed Nov. 17, 2011, the disclosure of which is hereby incorporated herein by reference in its entirety.

### TECHNICAL FIELD

This invention relates in general to windshield wipers, and more particularly, to carrier for a wiper strip that provides lateral rigidity to the wiper strip and allows the use of smaller wiper strips. The invention is also directed to windshield wipers incorporating these novel wiper strip carriers.

### BACKGROUND OF THE INVENTION

There are a variety of different types of wiper blades currently used on vehicles. “Traditional” or “conventional” wiper blades have a series of brackets (also called yokes or frames) arranged in tournament-style, which distribute the force from the wiper arm down to the wiper strip. “Beam” wiper blades, or beam blades, use a spring-elastic metal beam (also called a support element) to distribute the force from the wiper arm to the wiper strip. “Hybrid” wiper blades use both a beam and brackets to distribute the force from the wiper arm to the wiper strip.

Wiper strips have been made in a variety of shapes and sizes throughout the years. However, because a wiper strip is generally made from a soft material, such as natural or synthetic rubber, and the like, wiper strips generally have a pair of longitudinal grooves in which metal vertebrae are placed to provide lateral rigidity to the wiper strip. FIG. 6 shows a prior art wiper strip having two vertebrae located in its longitudinal grooves. In some beam blades, the beam (usually made from spring-elastic steel) is used in place of the metal vertebrae, either by having one beam placed on each side of the wiper strip, or by running the wiper strip through a longitudinal slot in a single beam. In addition to requiring vertebrae (or beams) for lateral rigidity, such wiper strips also require a thick base portion to allow proper tilting of the wiper lip of the wiper strip. This thicker base portion requires more material to make, and therefore increases the cost of manufacture, or forces wiper blade providers to use a lower grade rubber for their wiper strips in order to keep costs down.

One wiper blade provider, Rain-X uses a rigid plastic carrier in place of vertebrae. However, this carrier has to have grooves or notches cut into it so that it does not interfere with the bending of the beam, and additionally has a vertical portion which passes through a longitudinal slot in the beam and requires a separate gripping structure on the opposite side of the beam to hold it in place. Accordingly this carrier, while an elegant design, is expensive to make. Moreover, it requires a beam and gripping structure to function properly, and thus is not suitable for use with traditional or hybrid wiper blades.

Accordingly there is a need for an inexpensive wiper strip carrier which will not interfere with beam function, but can also be used on hybrid and/or traditional wiper blades.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

This invention is generally directed to novel wiper strip carriers for windshield wiper blades. More particularly, the invention relates, in part, to a wiper strip carrier which holds the wiper strip along its length. The invention is also directed to wiper blades incorporating the wiper strip carriers described herein.

In certain embodiments, the wiper strip carrier is a structure having a horizontal body from which two claw-like legs descend. The claw-like legs have a vertical portion which extends downward from the horizontal body, and a horizontal portion which extends inwards from the vertical portion such that the claw-like legs form therebetween a first cavity for the top portion of a wiper strip. The wiper strip carrier may also have a second cavity for a vertebra.

Certain other embodiments are directed to a wiper blade having a wiper strip, a wiper strip carrier, a connection device which connects the wiper blade to a wiper arm, and a supporting structure which distributes the force from the wiper arm. The wiper strip may have a top portion. The wiper strip carrier may have a horizontal body from which two claw-like legs descend, each of which have a vertical portion which extends downward from the horizontal body, and a horizontal portion which extends inwards from the vertical portion such that the claw-like legs form therebetween a first cavity for the top portion of a wiper strip. The wiper strip carrier may also have a second cavity for a vertebra.

### BRIEF DESCRIPTION OF THE DRAWINGS

FIG. 1 illustrates a cross-sectional of an embodiment of the wiper strip carrier and a wiper strip.

FIG. 2 illustrates a cross-sectional of another embodiment of the wiper strip carrier and a wiper strip.

FIG. 3 illustrates a cross-sectional of another embodiment of the wiper strip carrier and a wiper strip.

FIG. 4 illustrates a perspective view of the embodiment of the wiper strip carrier depicted in FIG. 1 with a wiper strip.

FIG. 5 illustrates a perspective view of the embodiment of the wiper strip carrier depicted in FIG. 1 attached to a hybrid wiper blade.

FIG. 6 illustrates a typical prior art wiper strip.

### DETAILED DESCRIPTION OF THE ILLUSTRATIVE EMBODIMENT

In one aspect, the invention is generally directed to a wiper strip carrier 10 for a windshield wiper 40 (or a windshield wiper incorporating same) that can be secured to the windshield wiper 40 by claws 43, clips 44, or other structures known in the art, and that can retain and secure a wiper strip. Those skilled in the art will recognize that the wiper strip carrier 10 can be fabricated from any suitable material known in the art, including without limitation, rigid or elastic plastics, synthetic and natural rubber compounds, etc. As shown in FIGS. 4 & 5, the material used is preferably elastic such that the carrier can bend without needing to have grooves or notches cut into the carrier 10.

In certain embodiments the wiper strip carrier may include a horizontal body and a pair of claw-like legs descending from the horizontal body, each having a vertical portion that extends downward from main body and a horizontal portion extending inward from the vertical portion, such that a first cavity capable of receiving a top portion of a wiper strip is formed therebetween. The wiper strip carrier may also include a second cavity for receiving a vertebra.

The second cavity for receiving a vertebra and the first cavity for receiving a top portion of a wiper strip may be separate in the wiper strip carrier. Alternatively, the second cavity for receiving a vertebra and the first cavity for receiving a top portion of a wiper strip are joined, forming a unitary cavity.

In certain embodiments, the wiper strip carrier may have recessed portions on the outer surface of its claw-like legs. The wiper strip carrier may also have recesses for receiving clips or claws from a wiper blade. The wiper strip carrier may also include securing surfaces for securing the wiper strip carrier relative to clips or claws from a wiper blade.

In certain embodiments, a wiper blade capable of connecting to a wiper arm includes a wiper strip comprising a wiper lip and a top portion, a vertebra, a wiper strip carrier, a connection device for connecting the wiper blade to a wiper arm, and a supporting structure that distributes the force from the wiper arm. The wiper strip carrier may include a horizontal body, a pair of claw-like legs descending from the horizontal body, wherein each claw-like leg comprises a vertical portion that extends downward from main body and a horizontal portion extending inward from the vertical portion, such that the pair of claw-like legs form therebetween a first cavity housing the top portion the wiper strip. The wiper strip carrier may also include a second cavity housing the vertebra. The supporting structure may have a securing structure securing the wiper strip carrier.

The wiper blade may include a wiper strip carrier wherein the second cavity housing the vertebra and the first housing the top portion of the wiper strip are separated. Alternatively, the second cavity housing the vertebra and the first cavity housing the top portion of the wiper strip may be joined, forming a unitary cavity.

In certain embodiments, the outer surface of the claw-like legs of the wiper strip carrier may have a recessed portion. The wiper blade may further include and the supporting structure further comprises clips or claws for securing the wiper strip carrier, and the wiper strip carrier may also have recesses for receiving the clips or claws.

In certain embodiments, the wiper blade of claim may also include one or more securing structures for securing the wiper strip carrier to the wiper blade. The wiper strip carrier may include one or more securing surfaces for securing the wiper strip carrier relative to the one or more securing structures. The wiper strip carrier may also include one or more recesses where the one or more securing structures may be seated when the wiper strip carrier may be secured.

In certain embodiments, the supporting structure of the wiper blade may include a plurality of brackets. In certain other embodiments, the supporting structure of the wiper blade may include a beam. In other embodiments, the supporting structure of the wiper blade may include a beam coupled to one or more brackets. In other embodiments, the supporting structure of the wiper blade may include a frame coupled to one or more beams.

In certain embodiments, the wiper strip carrier can be slidably inserted into the one or more securing structures.

In certain embodiments a wiper blade capable of connecting to a wiper arm may include a wiper strip comprising a wiper lip and a top portion, a wiper strip carrier, a connection device for connecting the wiper blade to the wiper arm, and a supporting structure that distributes a force from the wiper arm. The wiper strip carrier may include a horizontal body, a pair of claw-like legs descending from the horizontal body, wherein each claw-like leg comprises a vertical portion that extends downward from main body and a horizontal portion extending inward from the vertical portion, such that the pair of claw-like legs form therebetween a first cavity housing the top portion the wiper strip.

As depicted in FIGS. 1-3, the wiper strip carrier 10 is preferably configured to have a horizontal body from which a pair of claw-like legs 11 extend. The claw-like legs 11 may have a vertical portion which extends down from the horizontal body and a horizontal portion which extends inward such that the claw-like legs 11 form therebetween a first cavity 13 for the top portion 23 of a wiper strip 20. Embodiments of the wiper strip carrier 10 may be designed to be used with a variety of wiper strips 20. The wiper strips 20 may generally have a wiper lip 21 which touches the windshield of a car when the wiper blade is attached to the car, a neck 22 which allows the wipe lip to tilt from side to side during operation, and a top portion 23, which can be housed in the wiper strip carrier's 10 first cavity 13. The top portion 23 of the wiper strip is usually rectangular in shape, but can be round, elliptical, or any other suitable shape which can be secured within the first cavity 13.

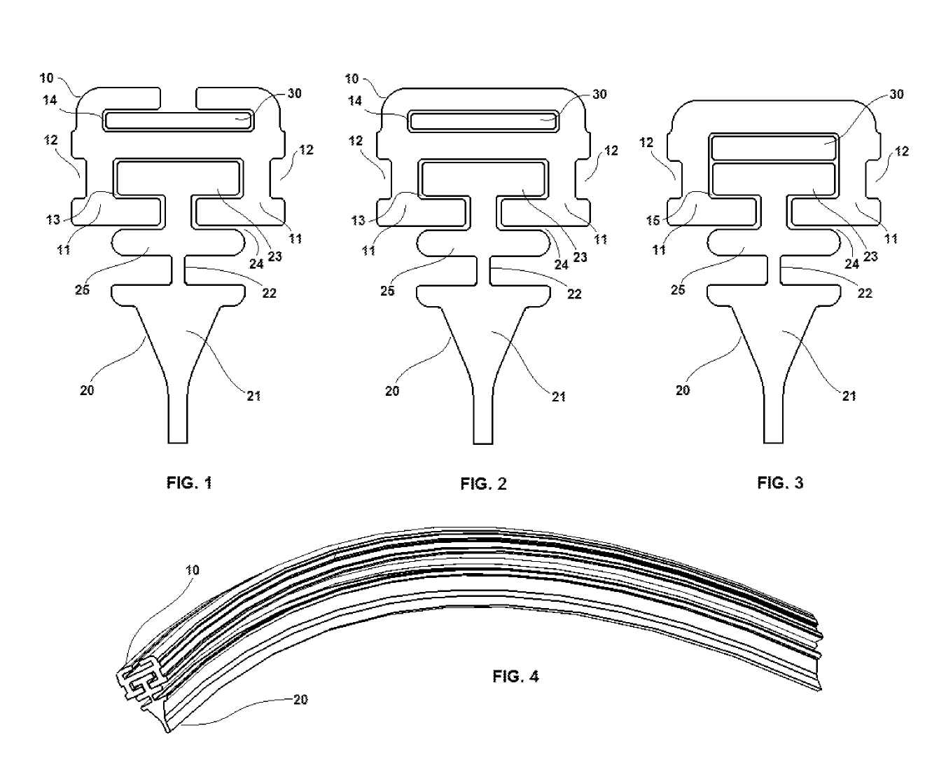

The wipe strip 20 may be secured to the wiper strip carrier 10 through friction by sizing the first cavity 13 and the gap between the inner edges of the horizontal walls of the claw-like legs 11. As show in FIGS. 1-2, the first cavity 13 and the top portion 23 of the wiper strip 20 may also be provided with complementary, form-fitting shapes. The wiper strip carrier may have securing structures to help secure the wiper strip 20 to the wiper strip carrier 10, including without limitations teeth or barbs which dig in to the wiper strip, detents in the wiper strip carrier 10 that fit into recesses in the wiper strip 20, recesses in the wiper strip carrier 10 that receive detents in the wiper strip 20; crimping, gluing, or any other method of securing a wiper strip 20 to the wiper strip carrier 10 known in the art. The wiper strip 20 may optionally have an intermediate portion 25, thereby forming a longitudinal groove between the intermediate portion 25 and the top portion 23 where the claw like legs 11 of the wiper strip carrier 10 can be housed. Indeed, persons of skill in the art will recognize that the invention may be practiced with any number of types of wiper strips and the modifications that can be made to the invention to accommodate such wiper strips.

The wiper strip carrier 10 may also have a second cavity 14 for a vertebra 30. A vertebra is a strip-like structure which gives the wiper strip additional lateral support and rigidity. A vertebra 30 is generally made of metal or spring-elastic metal, but may also be made from any other suitable material known in the art, including without limitation, plastics, composites, etc. The vertebra 30 also generally has a flat, rectangular (or near-rectangular) profile shape, but other shapes, including without limitation square, trapezoidal, round or elliptical shapes may be used. In some embodiments, such as the embodiment shown in FIGS. 1, 4 and 5, the second cavity 14 for a vertebra 30 may be formed by two claw-like structures that extend upwards from the horizontal body and form the second cavity 14 therebetween. In other embodiments, such as the embodiment shown in FIG. 2, the second cavity 14 may be bounded on all sides. In yet other embodiments, such as the embodiment shown in FIG. 3, the second cavity 14 may be joined to the first cavity 13, forming a unitary cavity 15 for both the top portion 23 of the wiper strip and the vertebra 30.

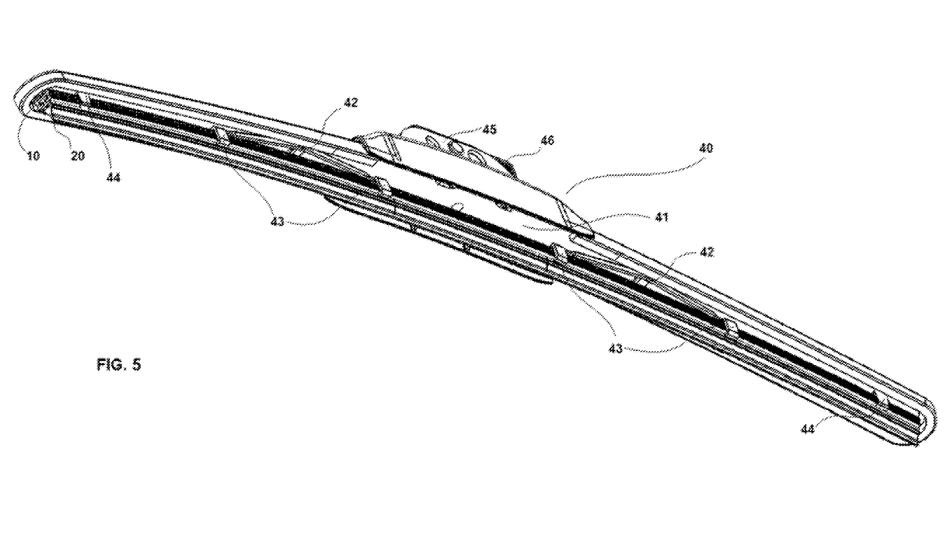

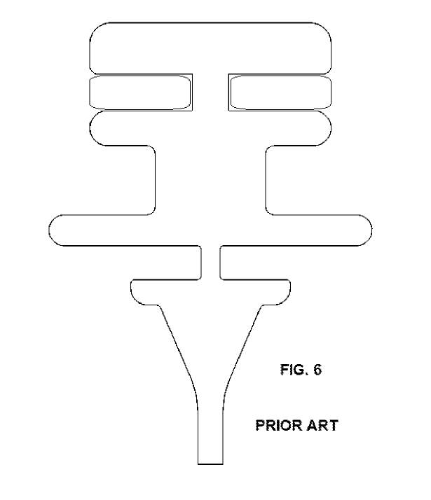

The wiper strip carrier 10 may be secured to the wiper blade 40 through the use of claws 43, clips 44 or any other suitable structure known in the art. In embodiments of the invention for traditional wiper blades and hybrid wiper blades, the ends of the brackets 42 which attach to the wiper strip carrier 10 may have claws 43 on the ends which can grip the wiper strip carrier. Likewise, embodiments of the invention for beam blades and hybrid blades may have clips 44 that attach to, or pass through the beam 41, to grip the wiper strip carrier. FIG. 5 shows an illustrative embodiment of the wiper strip carrier 10 on a hybrid wiper blade having both clips 44 through the beam 41 on the ends, and brackets 42 each having a pair of claws 43 in the middle of the blade. For ease of assembly, the wiper strip carrier 10 may be designed to be slidably inserted into the claw 43 or clips 44 with which it is used.

In some embodiments a recessed groove 12 may be included in the vertical portion of the claw-like leg such that the claws 43, clips 44, or other structures can grip the wiper strip carrier 10 at the recessed grooves 12. The claws 43, clips 44 or other structures may also grip the wiper strip carrier underneath the horizontal portion of the claw-like legs 11, as shown in FIG. 5.

In order to secure the wiper strip carrier 10 from sliding out longitudinally, the wiper strip carrier 10 may be provided with recesses or retaining shoulders to seat or engage with the clips 44 or claws 43, or any other suitable method known in the art. Alternatively, the wiper blade 40 may be provided with structures which secure the wiper strip carrier 10 or the wiper strip from longitudinal movement. For instance, the wiper blade 40 may have a structure which blocks further movement of the wiper strip carrier 10 past the end of the wiper blade 40. Some examples of such structures include, without limitation: providing the wiper blade with a cover having a lip or wall to prevent further movement of the wiper strip carrier 10; attaching a structure to the end of a beam 41, or bending the end of the beam 41 of a beam or hybrid blade downwards at the ends, in order to block the longitudinal movement of the wiper strip carrier 10; closing off the ends of the clips 44 or claws 43 at the ends of the beam to prevent further movement of the wiper strip carrier 10; providing the claws 43 or clips 44 with teeth, barbs or detents that engage the wiper strip 20, the wiper strip carrier 10, or recesses in either or both; or any method of securing a wiper strip currently known in the art. In FIG. 5, for example, the covers over the ends of the beam 41 of the wiper blade 40 are provided with a bottom lip which blocks longitudinal movement of the wiper strip carrier 10.

Another embodiment of the invention is a wiper blade provided with a wiper strip carrier 10 as described above, or as shown in FIGS. 1-5. The wiper blade 40 may be of any type suitable for use with the present invention. For example, the wiper blade 40 can be a traditional wiper blade having a plurality of brackets, one or more of which has a connecting structure, and some of which carry the wiper strip carrier 10, and a wiper strip 20. Alternatively, the wiper blade 40 may be a frameless blade, having one or more spring-elastic beams, a wiper element, and a mounting base 45 or other connection device. The wiper blade 40 may also be a hybrid wiper blade, which has a combination of a beam and one or more brackets, the wiper strip carrier 10, a wiper strip 20, and a mounting base 45 or other connection device. Any of these types of wiper blades, or any other wiper blade known in the art may be adapted to use a wiper strip carrier 10.

Regardless of the type of wiper blade 40, a connector 46, such as the connector described in U.S. Pat. No. 6,640,380, which is incorporated herein by reference, or any other such suitable connector, may be used together with the mounting base 45 or other connecting device to connect the wiper strip to various types of arms. In some cases adapters may also be used together with the mounting base 45 or other connecting device, and/or the connector 46 to connect to particular kinds of arms. Alternatively a connection device can be specifically designed to connect to one or more types of wiper arm without using connectors 46 or adapters.

Those skilled in the art will recognize that while the invention will most likely be used in conjunction with automobiles, it is suitable for use with any vehicle. For example, in addition to automobiles, trucks, buses, locomotives, aircrafts, or any other vehicle type that uses a windshield wiper can benefit from the invention.

While specific embodiments have been discussed to illustrate the invention, it will be understood by those skilled in the art that the descriptions herein are intended as illustrative, and not as limiting, and that variations in the embodiments can be made without departing from the spirit of the invention.

Accordingly, the foregoing descriptions are intended as illustrative, and not as limiting.

We claim:

1. A wiper strip carrier comprising:
a horizontal body;
a pair of claw-like legs descending from the horizontal body, wherein each claw-like leg comprises a vertical portion that extends downward from main body and a horizontal portion extending inward from the vertical portion, such that the pair of claw-like legs form therebetween a first cavity capable of receiving a top portion of a wiper strip; and
a second cavity for receiving a vertebra.

2. The wiper strip carrier of claim 1 wherein the second cavity for receiving a vertebra and the first cavity for receiving a top portion of a wiper strip are separated.

3. The wiper strip carrier of claim 1 wherein the second cavity for receiving a vertebra and the first cavity for receiving a top portion of a wiper strip are joined, forming a unitary cavity.

4. The wiper strip carrier of claim 1 wherein the outer surface of the claw-like legs further comprises a recessed portion.

5. The wiper strip carrier of claim 1 further comprising recesses for receiving clips or claws from a wiper blade.

6. The wiper strip carrier of claim 1 further comprising securing surfaces for securing the wiper strip carrier relative to clips or claws from a wiper blade.

7. A wiper blade capable of connecting to a wiper arm comprising:
a wiper strip comprising a wiper lip and a top portion;
a vertebra;
a wiper strip carrier comprising a horizontal body, a pair of claw-like legs descending from the horizontal body, wherein each claw-like leg comprises a vertical portion that extends downward from main body and a horizontal portion extending inward from the vertical portion, such that the pair of claw-like legs form therebetween a first cavity housing the top portion the wiper strip, and a second cavity housing the vertebra;
a connection device for connecting the wiper blade to the wiper arm;
a supporting structure that distributes a force from the wiper arm.

8. The wiper blade of claim 7 wherein the second cavity housing the vertebra and the first housing the top portion of the wiper strip are separated.

9. The wiper blade of claim 7 wherein the second cavity housing the vertebra and the first cavity housing the top portion of the wiper strip are joined, forming a unitary cavity.

10. The wiper blade of claim 7 wherein the outer surface of the claw-like legs further comprises a recessed portion.

11. The wiper blade of claim 7 wherein supporting structure further comprises clips or claws for securing the wiper strip carrier and the wiper strip carrier further comprises recesses for receiving the clips or claws.

12. The wiper blade of claim 7 wherein the supporting structure further comprises one or more securing structures for securing the wiper strip carrier.

13. The wiper blade of claim 12 wherein the wiper strip carrier further comprises one or more securing surfaces for securing the wiper strip carrier relative to the one or more securing structures of the supporting structure.

14. The wiper blade of claim 12 wherein the wiper strip carrier further comprises one or more recesses where the one or more securing structures may be seated when the wiper strip carrier is secured.

15. The wiper blade of claim 7 wherein the supporting structure comprises a plurality of brackets.

16. The wiper blade of claim 7 wherein the supporting structure comprises a beam.

17. The wiper blade of claim 7 wherein the supporting structure comprises a beam coupled to one or more brackets.

18. The wiper blade of claim 7 wherein the supporting structure comprises a primary frame coupled to one or more beams.

19. The wiper blade of claim 12 wherein the wiper strip carrier can be slidably inserted into the one or more securing structures.

20. A wiper blade capable of connecting to a wiper arm comprising:
a wiper strip comprising a wiper lip and a top portion;
a wiper strip carrier comprising a horizontal body, a pair of claw-like legs descending from the horizontal body, wherein each claw-like leg comprises a vertical portion that extends downward from main body and a horizontal portion extending inward from the vertical portion, such that the pair of claw-like legs form therebetween a first cavity housing the top portion the wiper strip;
a connection device for connecting the wiper blade to the wiper arm;
a supporting structure that distributes a force from the wiper arm.
